(19) United States
(12) Patent Application Publication
(10) Pub. No.: US 2015/0171665 A1
(43) Pub. Date: Jun. 18, 2015

(54) ALTERNATING POWER SOURCES TO MANAGE INPUT POWER IN A CONVERTER

(71) Applicants: Daniel Humphrey, Cypress, TX (US); Mohamed Amin Bemat, Cypress, TX (US)

(72) Inventors: Daniel Humphrey, Cypress, TX (US); Mohamed Amin Bemat, Cypress, TX (US)

(73) Assignee: Hewlett-Packard Development Company, L.P., Houston, TX (US)

(21) Appl. No.: 14/401,832

(22) PCT Filed: May 22, 2012
(86) PCT No.: PCT/US2012/038997

§ 371 Date: Nov. 17, 2014

(51) Int. Cl. H02J 9/06

(52) U.S. Cl. CPC H02J 9/061

(57) ABSTRACT

Examples disclose a system with a first converter input to receive a first input power from a first power source and a second converter input to receive a second input power from a second power source. Further, the examples provide the system with a converter to provide isolation between the first and second power input by a first plurality of switches and a second plurality of switches. Additionally, the examples also disclose a controller to manage the first and the second power input by alternating between the first power source and the second power source based on the first and the second plurality of switches.

### BACKGROUND

As technology increases, there is a greater dependence on providing reliability within a power supply system. Utilizing redundant power sources within the power system increases the reliability by providing another source of power when the input power source fails. This protects computers and systems when an unexpected power disruption occurs potentially causing injuries, data loss and/or business disruption.

### BRIEF DESCRIPTION OF THE DRAWINGS

In the accompanying drawings, like numerals refer to like components or blocks. The following detailed description references the drawings, wherein:

FIG. 1 is a block diagram of an example system including a first and a second power source with input to a converter and a controller to alternate between a first and a second input power;

FIG. 2 is a block diagram of an example system including a first and a second power source connected to a first and a second source module to supply a first and a second input power to a converter and a controller to alternate between the first and second input power based on the first and second plurality of switches;

FIG. 3 is a block diagram of an example controller to alternate between a first and a second power source by controlling a first and a second plurality of switches within a converter and to measure an output voltage from the converter;

FIG. 4A is a diagram of an example converter with a first and a second source to generate an output voltage across a transformer by switching between a first and a second plurality of switches, and a plurality of diodes to balance to the transformer;

FIG. 4B is a diagram of an example converter with a first and a second source to generate an output voltage across a transformer by switching between a first and a second plurality of switches, and a plurality of additional switches to balance to the transformer;

FIG. 4C is a diagram of an example converter with a first and a second source to generate an output voltage across a transformer by switching between a first and a second plurality of switches, and a plurality of capacitors to balance to the transformer; and

FIG. 5 is a flowchart of an example method performed on a computing device to receive input power and alternate the input power between a first and second power source.

### DETAILED DESCRIPTION

By providing a redundant power supply, systems prepare for a power failure situation. One solution provides redundant power sources and redundant converters. In this solution, the redundant power sources each utilize a redundant converter to receive power from the respective power source to provide a load. This solution is inefficient and increases costs. For example, the redundant power sources may interfere with one another diminishing the power density of the system. As a further example, the use of redundant converters increases the size of the system.

In another solution, redundant power supplies utilize the same converter. This solution uses two power sources to share a converter by both providing power to the load. However, this solution provides no isolation between the power sources, and thus may cause a power supply failure from one power source to the other power source. For example, current may leak from one power source to another causing the power supplies to cease functioning. Further, this solution may include multiple transformer windings for each power source. This reduces the power density and efficiency as each winding may suffer inductance leakage.

To address these issues, example embodiments disclosed herein provide a system with a first converter input to receive a first input power from a first power source and a second converter input to receive a second input power from a second power source. Further, the system includes a converter to provide isolation between the first input power and the second input power through a first and a second plurality of switches. Providing isolation between the first and second power input, obstructs a path of current to flow between the first and second power sources. This increases reliability of the redundant power system by preventing current leakage from one power source to another.

Additionally, the system provides a controller to manage the first and the second input power by alternating between the first and the second power source based on the first and second plurality of switches within the converter. Alternating between the first and the second power source enables the power sources to operate independently. Further, alternating between power sources also minimizes the need for a redundant converter as it enables the power sources to share the converter. Further still, alternating between the power sources while sharing the converter maintains efficiency, power density, and also reduces the size of the system. For example, reliability is increased by preventing a system failure when one of the power sources experiences a failure, then the system can skew power to the non-faulted power source.

In another embodiment, a first source module and a second source module conditions each power received from the first power source and the second power source to result in the first input power and the second input power, respectively. Conditioning each input power enables the first power source and the second power source to provide power and/or frequency at different levels. This enables the system to operate efficiently even though each power source may have mismatching characteristics.

In a further embodiment, the first and the second plurality of switches are each in series with a transformer to direct current through the transformer, resulting in a voltage on a load. Additionally, in this embodiment, the first converter input and the second converter input include at least one of a plurality of diodes, plurality of additional switches, and plurality of capacitors to direct the current through the transformer to balance the transformer. In this embodiment, the power sources share the transformer winding in the converter providing additional isolation between the converter and the load. Further in this embodiment, once transferring energy to power the load, the transformer is balanced ensuring the converter operates without saturation and/or breakdown of the transformer.

In summary, example embodiments disclosed herein provide a redundant power source system including a converter to provide isolation between the power sources to increase reliability. This also enables the power sources to operate independently of one another. Additionally, example embodiments maintain efficiency and power density while reducing the size of the power source system.

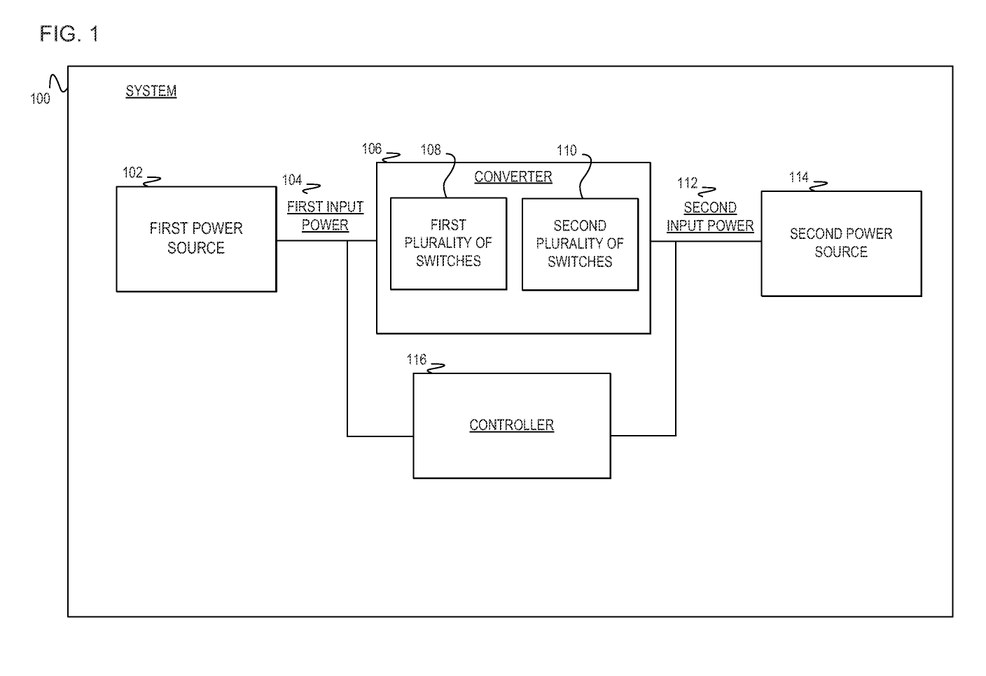

Referring now to the drawings, FIG. 1 is a block diagram of an example system 100 including a first power source 102 and a second power source 114 to transmit a first input power 104 and second input power 112 to a converter 106. Additionally, the system 100 includes a controller 116 to manage the first and the second power input 104 and 112, respectively, by alternating between the first power source 102 and the second power source 114 based on a first plurality of switches 108 and a second plurality of switches 110. The system 100 supports a redundant power system with the first power source 102, the second power source 114, and the converter 106 to provide a load. Embodiments of the system 100 include a computing device, server, or any other computing system suitable to support the first power source 102 and the second power source 114 and to provide the bad.

The first power source 102 is a device that supplies electrical power to the system 100 to power the load. Specifically, the first power source 102 provides the first input power 104 to the converter 106. In one embodiment, the first power source 102 may be external to the system 100 while in another embodiment, the first power source 102 may be internal to the system 100. In a further embodiment, the first power source 102 operates independently of the second power source 114. In this embodiment, the converter receives input power from either the first power source 102 or the second power source 114 (i.e., not simultaneously). In another embodiment, the controller 116 may detect a fault at either the first power source 102 or the second power source 114 and skews the input power 104 or 112 received at the converter 106 to either the first power source 102 or the second power source 114 (i.e., the non-faulted power source). Embodiments of the first power source 102 include a power supply, energy storage, battery, fuel cell, generator, alternator, solar power, electromechanical supply, or other power supply capable of providing the first input power 104 to the converter 106.

The first input power 104 is the power as transmitted by the first power source 102 and received by the converter 106 at the first converter input. The first input power 104 is the electrical energy provided from the first power source 102 and received at the converter 106 and as such, embodiments of the first input power 104 include current, voltage, electrical charge, or other type of electrical energy provided by the first power source 102.

The second power source 114 transmits electrical energy (i.e., the second input power) to the converter 106. The second power source 114 may be similar in structure and functionality to the first power source 102 and as such, embodiments of the second power source 114 include a power supply, energy storage, battery, fuel cell, generator, alternator, solar power, electromechanical supply, or other power supply capable of providing the second input power 112 to the converter 106. In another embodiment, the second power source 114 may be a different type of power source from the first power source 102. For example, the second power source 114 may include a battery and the first power source 102 may include a generator. In this embodiment, the first power source 102 and the second power source 114 may be different types of power sources. In another embodiment, the first power source 102 and the second power source 114 may provide different power and/or frequency levels. In this embodiment, a first and a second source module are each connected between the power sources 102 and 114 to the converter 106. This embodiment is explained in detail in the next figure.

The second input power 112 is the power as transmitted by the second power source 114 and received by the converter 106 at the second converter input. The second converter input is considered a different input from the first converter input as indicated with the two lines from the first power source 102 and the second power source 114 providing two different input powers (i.e., the first input power 104 and the second input power 112) to the first converter input and the second converter input. The second input power 112 may be similar in functionality and structure to the first input power 104 and as such embodiments include current, voltage, electrical charge, or other type of electrical energy provided by the second power source 114.

The controller 116 manages the first input power 104 and the second input power 112 as indicated with connecting lines from the controller 116 to each of the input powers 104 and 112. Additionally, the controller 116 alternates between the first power source 102 and the second power source 114 based on the first plurality of switches 108 and the second plurality of switches 110 in the converter 106. The controller 116 transmits a signal to the converter 106 to the first plurality of switches 108 and the second plurality of switches 110 to open or close. In this embodiment, the controller 116 alternates between the first power source 102 and the second power source 114 so the converter receives input power from either the first power source 102 or the second power 114, but not both simultaneously. In a further embodiment, the controller 116 includes a first channel and a second channel connecting the controller 116 to the converter 106 and the power sources 102 and 114. This embodiment is depicted in detail in later figures. Embodiments of the controller 116 include a processor, circuit logic, a set of instructions executable by a processor, a microchip, chipset, electronic circuit, microprocessor, semiconductor, microcontroller, central processing unit (CPU), graphics processing unit (CPU), visual processing unit (VPU), or other device capable of managing the first input power 104 and the second input power 112 by alternating between the first power source 102 and the second power source 114.

The converter 106 is an electrical device that receives the first input power 104 at the first converter input and the second input power 112 at the second converter input. Additionally, the converter 106 includes the first plurality of switches 108 and the second plurality of switches 110 to receive the signal from the controller 116 to manage the first input power 104 and the second input power 112 so power is provided by either the first power source 102 or the second power source 114. In one embodiment, the converter 106 includes a transformer in series with each of the first and the second plurality of switches 108 and 110. In another embodiment, the converter 106 includes the transformer to share between the first and the second input power 104 and 112 to achieve an output voltage across the transformer. In a further embodiment, the converter 106 includes at least one of a plurality of diodes, a plurality of additional switches, and a plurality of capacitors to direct current through the transformer. Yet, in a further embodiment, the converter 106 includes a configuration of at least a full-bridge type converter, a half-bridge type converter, and/or a plurality of transistors converter. These embodiments are described in detail in later figures. Embodiments of the converter 106 include a voltage converter, electronic converter, or other type of converter suitable of including the first and the second plurality of switches 108 and 110 and capable of receiving the first and the second power input 104 and 112.

The first plurality of switches 108 are electrical devices that provide isolation between the first input power 104 and the second input power 112. In this embodiment, the first and the second input power 104 and 112 are isolated which also provides isolation between the first and the second power source 102 and 114. The isolation prevents current leakage from the first power source 102 to the second power source 114 and vice versa through a connection path between the first and the second power sources 102 and 114. The isolation prevents the first power source 102 from suffering a failure once the second power source 114 has suffered a failure and vice versa. Embodiments of the first plurality of switches 108 include switches, transistors, or other type of electrical devices to provide isolation from the first power source 102 to the rest of the system 100.

The second plurality of switches 110 provides isolation from the second power source 114 to the rest of the system 100. The second plurality of switches 110 may be similar in functionality and structure to the first plurality of switches 108 and as such, embodiments of the second plurality of switches 110 include switches, transistors, or other electrical devices to provide isolation from the second power source 114 to the rest of the system 100.

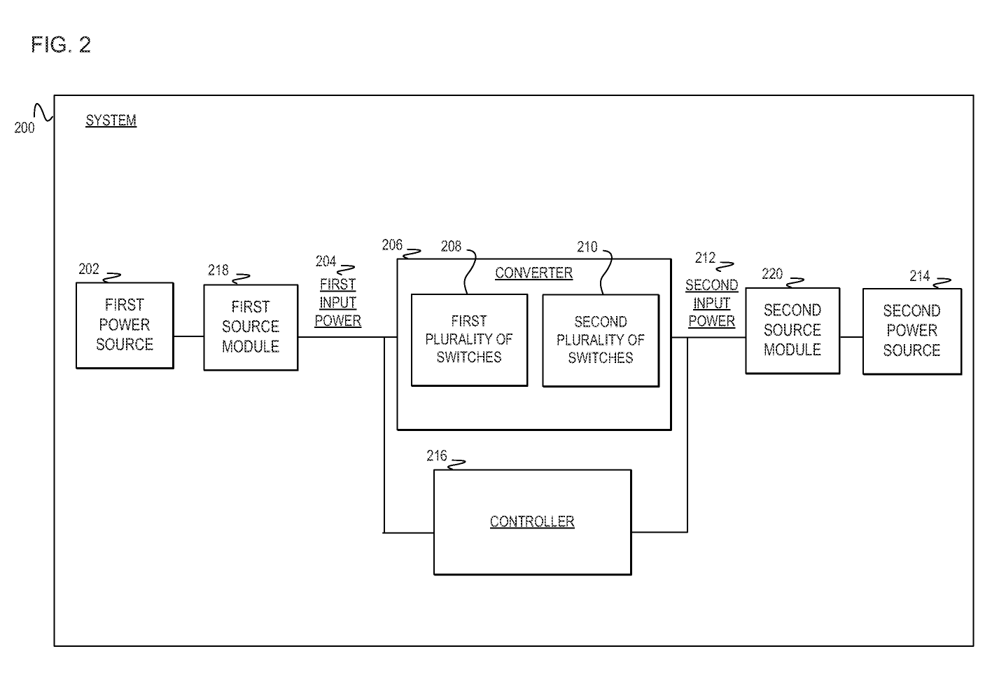

FIG. 2 is a block diagram of an example system 200 including a first and second power source 202 and 214 to transmit power to a first and a second source module 218 and 220. The first and the second source module 218 and 220 transmit a first and a second input power 204 and 212 to a converter 206. The converter 206 includes a first and a second plurality of switches 208 and 210 to alternate between the input powers 204 and 212 as managed by a controller 216. The system 200 may be similar in structure and functionality to the system 100 as in FIG. 1.

The first power source 202 connects to the first source module 218 to provide the first input power 204. The first source module 218 conditions the power from the first power source 202 to produce the first input power 204. The first power source 202 may be similar in structure and functionality to the first power source 102 as in FIG. 1.

The first source module. 218 receives power from the first power source 202 to condition the power resulting in the first input power 204. In this embodiment, the power from the first power source 202 is conditioned to the first input power 204 for the converter 206 to accept. For example, the converter 206 may be rated for 380 Volts DC, while the first power source may provide 220 Volts at 50 Hz, thus the first source module 218 conditions the 220 Volts at 50 Hz, to result in the first input power 204 of a rating 380 Volts DC. This enables the first power source 202 and the second power source 214 to provide power and/or frequency at different levels as the first source module 218 and the second source module 220 will condition and/or shape power to an acceptable rating according to the converter 206. Embodiments of the first source module 218 include a power factor correcting module, a power rectifier, circuit logic, DC to DC converter module, or other source module to condition the power from the first power source 202 to result in the first input power 204.

The first input power 204 is the resulting power conditioned by the first source module 218 to provide to the converter 206 to a first converter input. The first input power 204 may be similar in structure and functionality of the first input power 104 as in FIG. 1.

The second power source 214 transmits power to the second source module 220. The second power source 214 may be similar in structure and functionality of the second power source 114 as in FIG. 1.

The second source module 220 receives power from the second power source 214 and conditions the power to result in the second input power 212. The second source module 220 may be similar in functionality and structure to the first source module 218 and as such, embodiments of the first source module 220 include a power factor correcting module, a power rectifier, circuit logic, DC to DC converter module, or other source module to condition the power from the second power source 214 to result in the second input power 212.

The second input power 212 is the resulting power as conditioned by the second source module 220 for the converter 206 to receive at a second converter input. The second input power 212 may be similar in functionality and structure to the second input power 112 of FIG. 1.

The converter 206 includes the first plurality of switches 208 and the second plurality of switches 210. The converter 206, the first plurality of switches 208, and the second plurality of switches 210 may be similar in functionality and structure of the converter 106, the first plurality of switches 108, and the second plurality of switches 110 of FIG. 1.

The controller 216 transmits a signal to the converter 206 to switch between the first and the second plurality of switches 208 and 210, thus alternating the power received by the converter 206 between the first power source 202 and the second power source 214. The controller 216 may be similar in functionality and structure of the controller 116 of FIG. 1.

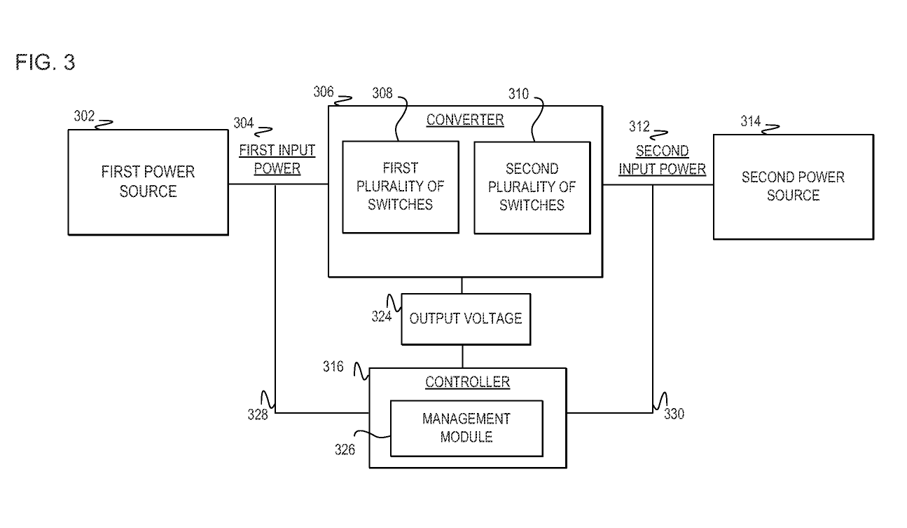

FIG. 3 is a block diagram of an example controller 316 to alternate between a first power source 302 and a second power source 314 by controlling a first plurality of switches 308 and a second plurality of switches 310 within a converter 306 and to maintain an output voltage 324 from the converter 306 by measuring the output voltage 324. The first power source 302, the first input power 304, the second power source 314, and the second input power 312 may be similar in structure and functionality to: the first power source 102 and 202; the first input power 104 and 204; the second power source 114 and 214; and the second input power 112 and 212 as in FIGS. 1-2.

The converter 306 includes the first plurality and the second plurality of switches 308 and 310 and provides the output voltage 324. The converter 306, the first plurality of switches 308, and the second plurality of switches may be similar in structure and functionality to: the converter 106 and 206; the first plurality of switches 108 and 208; and the second plurality of switches 110 and 210 as in FIGS. 1-2.

The controller 316 includes the management module 326, the first channel 328, and the second channel 330 to manage the first and the second input power 304 and 312 by transmitting a signal through the channels 328 and 330 to the converter 306 to close or open the first and the second plurality of switches 308 and 310. In another embodiment, the controller 316 maintains the output voltage 324 by measuring this voltage 324. Further, in this embodiment, the controller 316 measures the output voltage 324 by a sensor and determines if the output voltage 324 is high or low and switches either the first input power 304 or the second input power 312 on or off with the first and the second plurality of switches 308 and 310.

The first channel 328 connects the controller 316 to first power source 302 and to the converter 306 at the first converter input. The first channel 328 controls the first plurality of switches 308 by transmitting signals to the converter 306 to open and/or close the first plurality of switches 308.

The second channel 330 connects the controller 316 to the second power source 314 and to the converter 306 at the second converter input. The second channel 330 controls the second plurality of switches 310 by transmitting signals to the converter 306 to open and/or close the second plurality of switches 310.

The management module 326 manages the first input power 304 and the second input power 312 by alternating between the first power source 302 and the second power source 314 based on the first and the second plurality of switches 308 and 310 within the converter 306. The first and the second plurality of switches 308 and 310 provide isolation between the power sources 302 and 314 to prevent current leakage between these sources 302 and 314. Preventing current leakage between the first and the second power sources 302 and 314 provides additional reliability so if one of the power sources 302 and 314 is experiencing a fault, it will not affect the non-faulted sources 302 and 314. Embodiments of the management module 326 include circuit logic, a set of instructions executable by a processor to manage the first and the second input power 304 and 312.

The output voltage 324 from the converter 306 is measured by the controller 316. In one embodiment, the output voltage 324 may also be a circuit load. The controller 316 may measure the output voltage 324 using a sensor, circuit logic, voltmeter, voltage divider, or other device and/or technique capable of measuring the output voltage 324.

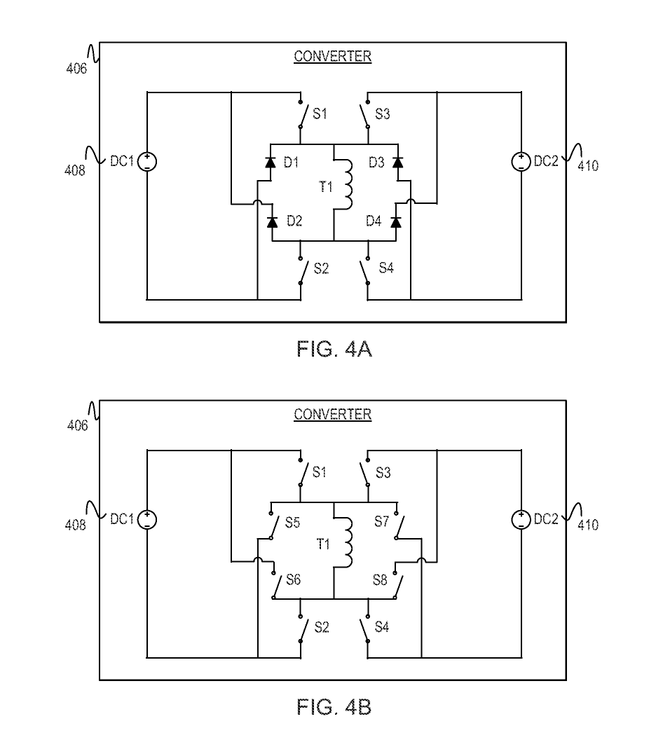

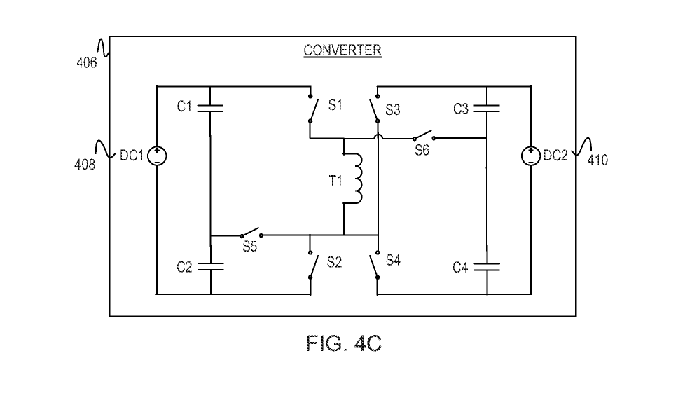

FIG. 4A is a diagram of an example converter 406 with a first and second power source 408 and 410 to create an output voltage across a transformer T1 by switching between a first plurality of switches S1-S2, a second plurality of switches S3-S4, a first plurality of diodes D1-D2, and a second plurality of diodes D3-D4 to balance the transformer T1. The converter 406 may be similar in structure and functionality to the converter 106, 206, and 306 as in FIGS. 1-3. In another embodiment, FIG. 4B depicts a configuration of a plurality of transistors converter. In this embodiment each of the switches S1-S4 and the corresponding diodes D1-D4 are replaced with a transistor. For example, in this embodiment, S1 and D1 would be replaced with a first transistor providing a plurality of transistors in this configuration.

The first and the second sources 408 and 410 provide power to the first plurality of switches S1-S2 or the second plurality of switches S3-S4 to generate an output voltage across the transformer T1. Additionally, the first and the second sources 408 and 410 alternate providing power to the transformer T1 to achieve the output voltage based on the first plurality of switches S1-S2 and the second plurality of switches S3-S4. For example, the first plurality of switches S1-S2 close to provide power to the transformer T1 from the first source 408 while the second plurality of switches S2-S4 remain open. In another example, the second plurality of switches S3-S4 close to provide power to the transformer T1 from the second source 410 while the first plurality of switches S1-S2 remain open. In these embodiments, the converter 406 alternates power based on the first and the second plurality of switches S1-S4. Although the first the second sources 408 and 410 are depicted as internal to the converter 406, this was done for illustration purposes rather than for limiting purposes. For example, the sources 408 and 410 may be external to the converter 406 as depicted in FIGS. 1-3. In another embodiment, the sources 408 and 410 may include a first source module and a second source module to condition power from each power source 408 and 410 to achieve a first power input and a second power input. In a further embodiment, the sources 408 and 410 may include a first and a second power source. Yet, in another embodiment, the first source 408 and the second source are capacitors charged when receiving power from the first power source and the second power source to transfer power through the first plurality of switches S1-S2 and the second plurality of switches S3-S4 to generate the output voltage across the transformer T1.

The first plurality of switches S1-S2 are in series with the transformer T1 to achieve the output voltage from the first source 408. For example, a controller transmits a signal to the converter 406 to close switches S1-S2 allowing a direct path for the first source 408 to transmit power through switch S1, the transformer T1, and switch 32. In this embodiment, when the first power source 408 supplies current through the transformer T1, the second plurality of switches S3-S4 are left open. In this regard, the power sources 408 and 410 alternate supplying power to the converter 406. Alternating between the two power sources 408 and 410 may be accomplished by manipulating the number of times the first source 408 or the second source 410 supplies power to the converter 406. For example, this may be done equally such alternating between each cycle, alternating after a period of time, or until either source 408 or 410 experiences a fault and then power will be supplied by the non-faulted source 408 or 410.

The second plurality of switches S3-S4 are in series with the transformer T1 to achieve the output voltage from the second source 410. For example, the controller transmits a signal to the converter 406 to close switches S3-S4 allowing a direct path for the second source 410 to transmit power through switch S3, the transformer T1, and the switch S4. When the second plurality of switches S3-S4 are closed, the first plurality of switches S1-S2 are open. The controller manages a first and a second input power by alternating between the sources 408 and 410 based on the first plurality of switches S1-S2 and the second plurality of switches S3-S4 to generate the output voltage across the transformer T1. For example, the controller transmits a signal to the converter 406 to close the first plurality switches S1-S2 so power flows from the first source 408 through the transformer T1 to achieve the output voltage. When the duty cycle is met to achieve an output voltage, the converter 406 opens the first plurality of switches S1-S2 which allows the current to flow from the negative end of the first source 408 through D1-D2. The duty cycle is the time a device has “on time” (i.e., voltage applied across the device). In order to prevent breakdown of the device, there is an “off time” (i.e, reverse voltage applied across the device). For example, for a 60% duty cycle, the device will have a positive voltage applied across it for 60% of the time and will be off for 40% of the time. Here the time is the length of time it takes the device to go through a complete on/off cycle. In a further example, the controller transmits a signal to close the second plurality of switches S3-S4 so power flows from the second source 410 through the transformer T1 to achieve the output voltage. When the duty cycle is met, the converter 406 opens the second plurality of switches S3-S4 which allows the current to flow from the negative end of the second source 410 to through D3-D4, balancing the transformer T1. In this example, the second power source 410 is isolated from the converter 406 through the second plurality of switches S3-S4 as to prevent current leakage between the sources 408 and 410.

The transformer T1 is an electrical device that transfers energy from the converter 406 to a load through a magnetic medium. The transformer T1 is in series with the first and the second plurality of switches S1-S2 and S3-S4 and is shared between the power sources 408 and 410 to generate the load. The voltage across the transformer T1 alternates between the power sources 408 and 410 as based on whether the first and the second plurality of switches S1-S2 and S3-S4 are open or dosed. For example, the converter 406 will receive a single input across the transformer T1 to achieve the output voltage and as such the power input may come from either of the power sources 408 and 410. Further, the transformer T1 provides additional isolation between the converter 406 and the bad and/or output voltage. The bad is provided as the output voltage from the converter 406.

The first plurality of diodes D1-D2 are in series with the first source 408 that operate to balance the transformer T1 when the first source 408 supplies power through the first plurality of switches S1-S2. The first plurality of diodes D1-D2 are electrical devices with transfer characteristics to direct current flow in one direction with low resistance from an anode to the cathode. The other side of the diode from the cathode to the anode operates with high resistance thus preventing the flow of current from the cathode to the anode. The first plurality of diodes D1-D2 balance the transformer T1 when the first plurality of switches S1-S2 are dosed.

The second plurality of diodes D3-D4 are in series with the second source 410 that operate to balance the transformer T1 when the second source 410 supplies power through the second plurality of switches S3-S4. The second plurality of diodes D3-D4 may be similar in structure and functionality to the first plurality of diodes D1-D2.

FIG. 4B is a diagram for an example converter 406 with a first and second source 408 and 410 to generate an output voltage across a transformer T1 by switching between the first plurality of switches S1-S2, the second plurality of switches S3-S4, and a plurality of additional switches S5-S8 to balance the transformer T1. FIG. 4B, unlike FIG. 4A, provides the plurality of additional switches S5-S8 to balance the transformer T1. The first source 408, the second source 410, the converter 406, the first plurality of switches S1-S2, and the second plurality of switches S3-S4 may be similar in structure and functionality to the first source 408, the second source 410, the converter 406, the first plurality of switches S1-S2, and the second plurality of switches S3-S4 of FIG. 4A. In another embodiment, FIG. 4B depicts a configuration of a full-bridge type converter.

The plurality of additional switches S5-S6 and S7-S8 are each in series with the sources 408 and 410 to balance the transformer T1. In order to achieve the output voltage across the transformer T1, a controller alternates the power to the converter 406 between the first source 408 and the second source 410 by signaling to close and/or open the first plurality of switches S1-S2 or the second plurality of switches S3-S4. Further, once achieving the output voltage, the plurality of additional switches S5-S8 are utilized to provide a reverse voltage across the transformer T1.

The components for the first source 408 include the first plurality of switches S1-S2, additional plurality of switches S5-S6, and the transformer T1. In this embodiment, to achieve the output voltage across the transformer T1 from the first source 408 and to balance the transformer T1, the controller communicates with the converter to close the first plurality of switches S1-S2, while switches S5-S6 and the rest of the switches S3-S4 and S7-S8 remain open. To balance the transformer T1 by applying the reverse voltage, switches S5-S6 are closed while the first plurality of switches S1-S2 and the rest of the switches S3-S4 and S7-S8 remain open.

The components for the second source 410 include the second plurality of switches S3-S4, additional plurality of switches S7-S8, and the transformer T1. In this embodiment, to achieve the output voltage across the transformer T1 from the second source 410 and to balance the transformer T1, the controller communicates with the converter to close the second plurality of switches S3-S4, while switches S7-S8 and the rest of the switches S1-S2 and S5-S6 remain open. To balance the transformer T1 by applying the reverse voltage, switches S7-S8 are closed while switches S3-S4 and the rest of the switches S1-S2 and S5-S6 remain open.

FIG. 4C is a diagram of an example converter 406 with a first and second source 408 and 410 to generate an output voltage across a transformer T1 by switching between a first plurality of switches S1-S2 and a second plurality of switches S3-S4, and a plurality of capacitors C1-C4 to balance the transformer T1. FIG. 4C, unlike FIGS. 4A-4B, provides a plurality of capacitors to balance the transformer T1. The first source 408, the second source 410, the converter 406, the first plurality of switches S1-S2, and the second plurality of switches S3-S4 may be similar in structure and functionality to the first source 408, the second source 410, the converter 406, the first plurality of switches S1-S2, and the second plurality of switches S3-S4 of FIGS. 4A-4B. In another embodiment, FIG. 40 depicts a configuration of a half-bridge type converter.

The components for the first source 408 include the first plurality of switches S1-S2, and 55, the plurality of capacitors C1-C2, and the transformer T1. In this embodiment, to achieve the output voltage across the transformer T1 from the first source 408, the controller communicates with the converter 406 to close switches S1 and 55 while leaving S2 open. The converter 406 balances the transformer T1 by applying the reverse voltage across T1, the controller communicates with the converter 406 to open the switch S1 and close switches S5 and S2. During this embodiment, the switches S3-S4, and S6 on the second source side 410 remain open, providing isolation between the sources 408 and 410.

The components for the second source 410 include the second plurality of switches S3-S4, and S6, the plurality of capacitors C3-C4, and the transformer T1. In this embodiment, to achieve the output voltage across the transformer T1 from the second source 410, the controller communicates with the converter 406 to close switches S3 and S6 while leaving S4 open. The converter 406 balances the transformer T1 by applying the reverse voltage across T1, the controller communicates with the converter 406 to open switch S3 and close switches S4 and S6. During this embodiment, the switches S1-S2 and S5 remain open.

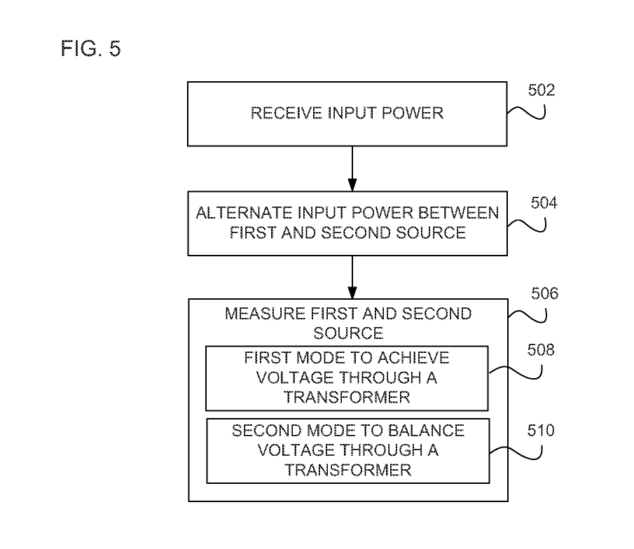

FIG. 5 is a flowchart of an example method performed on a computing device to receive an input power and alternate the input power between a first and a second power source. Although FIG. 5 is described as being performed on a computing device, it may also be executed on other suitable components as will be apparent to those skilled in the art. For example, FIG. 5 may be implemented in the form of executable instructions on a controller, such as 116, 216, and 316 as in FIGS. 1-3.

At operation 502, the converter receives input power from either the first power source or the second power source. In one embodiment, the input power may include a first input power or a second input power. Further in this embodiment, the input power is provided by either the first power source or the second power source, but not both sources.

At operation 504 the converter alternates the input power received at operation 502 between the first power source and the second power source by switching a first plurality and a second plurality of switches. In another embodiment, operation 504, results in an output voltage across a transformer and thus powering a load.

At operation 506 a controller measures power from the first power source and the second power source received at operation 502 so the converter operates between the modes at operations 508 and 510. Further, the converter operates in each mode at operations 508 and 510 for period of time as dependent on the first and the second power source measurements. For example, if the first source power measurement is in the higher range of voltages, the converter may then enter the mode to balance the transformer to prevent a breakdown of the transformer.

At operation 508, the first mode achieves a voltage through a transformer as shared between the first and the second power source. The first mode achieves the voltage in order to power a load from the converter. In another embodiment, operation 508, achieves a voltage output across a transformer. Achieving the voltage output enables the energy to transfer through the transformer to power a load.

At operation 510, the second mode includes balancing the voltage through the transformer. This mode allows the converter to balance the transformer. For example, the transformer may achieve voltage for a period of time, but may operate at duty cycle of 50%, therefore, the transformer may have a negative voltage as to balance out the voltage of the load. This prevents saturation and breakdown of the transformer.

In summary, example embodiments disclosed herein provide a redundant power source system including a converter to provide isolation between the power sources to increase reliability. This also enables the power sources to operate independently of one another. Additionally, example embodiments maintain efficiency and power density reducing the size of the power source system.

We claim:

1. A system comprising:
a first converter input to receive a first input power from a first power source and a second converter input to receive a second input power from a second power source;
a converter to provide isolation between the first and the second input power by a first plurality of switches connected to the first converter input and a second plurality of switches connected to the second converter input; and
a controller to manage the first and the second input power by alternating between the first power source and the second power source based on the first plurality of switches and the second plurality of switches.

2. The system of claim 1 wherein the controller is further to:
maintain an output voltage of the converter by measuring the output voltage and based on the output voltage, utilizing the first and the second plurality of switches to switch either the first or second input power on or off.

3. The system of claim 1 further comprising:
a first source module connected from the first power source to the first converter input to condition the first input power to a power as rated by the converter; and
a second source module connected from the second power source to the second converter input to condition the second input power to the power as rated by the converter.

4. The system of claim 1 wherein the controller is further to:
detect a fault and skew input power to either the first power source or the second power source.

5. The system of claim 1 wherein the converter further includes a transformer shared between the first converter input and the second converter input and further powered by either the first or the second power source, to achieve an output voltage.

6. The system of claim 5 wherein the first converter input and the second converter input includes at least one of the following:
a plurality of diodes, a plurality of additional switches, and a plurality of capacitors to direct a current through the transformer to balance the transformer.

7. The system of claim 1 wherein the converter includes at least one of the following configurations: a full-bridge type converter, a half-bridge type converter, and a plurality of transistors converter.

8. The system of claim 1 wherein the first and the second plurality of switches are in series with a transformer to direct a current through the transformer to transfer energy, resulting in an output voltage of the converter.

9. A controller comprising:
a first channel, connected between a first source and a first converter input, to control a first plurality of switches within a converter, the first converter input to receive a first input power from the first power source;
a second channel, connected between a second power source and a second converter input, to control a second plurality of switches within the converter, the second converter input to receive a second input power from the second power source; and
a management module to manage the first input power and the second input power by alternating between the first power source and the second power source based on the first and second plurality of switches, the first and the second plurality of switches provide isolation between the first power source and the second power source to prevent current leakage between the sources.

10. The controller of claim 9, wherein the management module is further to:
maintain an output voltage of the converter by measuring the output voltage and based on the output voltage, utilizing the first and the second plurality of switches to switch either the first or second input power on or off.

11. The controller of claim 9 wherein:
the first and the second plurality of switches within the converter are each in series with a transformer to direct a current through the transformer resulting in a positive voltage on a load; and
the first converter input and the second converter input include at least one of the following: a plurality of diodes, a plurality of additional switches, and a plurality of capacitors to direct the current through the transformer to balance the transformer.

12. The controller of claim 9 wherein the management module is further to detect a fault on either the first source or the second source and skew input power to either the first input power or the second input power.

13. The controller of claim 9 wherein the management module alternates between the first source and the second source in time intervals.

14. A method, executed by a computing device, comprising:
receiving input power from either a first power source or a second power source; and
alternating the input power between the first power source and the second power source based on a first plurality of switches associated with the first power source and a second plurality of switches associated with the second power source, the first and the second plurality of switches provide current isolation between the first power source and the second power source.

15. The method of claim 14 further comprising:
measuring the first power source and the second power source to enable the converter to alternate between two or more modes for a period of time, the period of time dependent on the first and second power source measurements, the modes including:
a first mode to achieve a voltage through a transformer;
a second mode to balance the voltage through the transformer.
